(19) United States
(12) Patent Application Publication
(10) Pub. No.: US 2026/0316823 A1
(43) Pub. Date: Oct. 15, 2026

(54) FAULT-TOLERANT TRANSITION TO DRIVER-OPERATED STEERING

(71) Applicant: Rivian IP Holdings, LLC, Irvine, CA (US)

(72) Inventors: Frederik Francois BOTES, Ontario, CA (US); Daniel James SLIPPER, Wigston (GB); Siddharth MULAY, Santa Clara, CA (US); Venkata Satya KOSURU, Sunnyvale, CA (US); Pratap Bharatraj SINGH, Fremont, CA (US); Sameer KOLTE, Santa Clara, CA (US); ByungJoo KIM, San Jose, CA (US); Rutvik TOPKAR, Fremont, CA (US)

(21) Appl. No.: 19/179,678

(22) Filed: Apr. 15, 2025

(51) Int. Cl. B62D 6/00; G06F 11/07; G07C 5/08

(52) U.S. Cl. CPC B62D 6/00; G06F 11/0739; G06F 11/0793; G07C 5/0808

(57) ABSTRACT

In certain embodiments, a method of transitioning to driver-operated steering of a vehicle includes providing, by a first vehicle system, an automatic steering feature for the vehicle. The method also includes detecting, by a second vehicle system, a fault in the first vehicle system. The method also includes, responsive to the fault, the second vehicle system taking control of the automatic steering feature from the first vehicle system and providing the automatic steering feature for a defined period based on a pre-calculated dataset generated by the first vehicle system prior to the fault.

### INTRODUCTION

The present disclosure relates to vehicles and more particularly, but not by way of limitation, to vehicle autonomous driving.

### SUMMARY

In certain embodiments, one general aspect includes a method of transitioning to driver-operated steering of a vehicle. The method includes providing, by a first vehicle system, an automatic steering feature for the vehicle. The method also includes detecting, by a second vehicle system, a fault in the first vehicle system. The method also includes, responsive to the fault, the second vehicle system taking control of the automatic steering feature from the first vehicle system and providing the automatic steering feature for a defined period based on a pre-calculated dataset generated by the first vehicle system prior to the fault.

In certain embodiments, another general aspect includes a control system for a vehicle. The control system includes a first vehicle system operable to provide an automatic steering feature for the vehicle. The system also includes a second vehicle system communicably coupled to the first vehicle system and operable to perform operations that include detecting a fault in the first vehicle system. The operations further include, responsive to the fault, taking control of the automatic steering feature from the first vehicle system and providing the automatic steering feature for a defined period based on a pre-calculated dataset generated by the first vehicle system prior to the fault.

In certain embodiments, another general aspect includes a computer-program product including a non-transitory computer-usable medium having computer-readable program code embodied therein. The computer-readable program code is adapted to be executed to implement a method of transitioning to driver-operated steering of a vehicle. The method includes providing, by a first vehicle system, an automatic steering feature for the vehicle. The method also includes detecting, by a second vehicle system, a fault in the first vehicle system. The method also includes, responsive to the fault, the second vehicle system taking control of the automatic steering feature from the first vehicle system and providing the automatic steering feature for a defined period based on a pre-calculated dataset generated by the first vehicle system prior to the fault.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2A is a schematic block diagram of a control system of a vehicle in accordance with certain embodiments.

FIG. 2B is a schematic block diagram of an alternative control system of a vehicle in accordance with certain embodiments.

FIG. 3 illustrates an example of a control system for providing fault tolerance for automatic steering features in accordance with certain embodiments.

FIGS. 4A and 4B illustrate example operation of the control system of FIG. 3 to provide fault tolerance in accordance with certain embodiments.

FIG. 5 illustrates an example of a process for generating and storing a lateral control frame in accordance with certain embodiments.

FIG. 6 illustrates an example of a process for generating and storing a lateral control frame in accordance with certain embodiments.

### DETAILED DESCRIPTION

A vehicle may include a control system that provides an advanced driver-assistance system (ADAS). The ADAS can provide various features that assist a driver in safe operation of the vehicle, for example, by providing warnings or performing certain driving tasks, such as steering, accelerating, or braking. In general, the ADAS can enable the control system to operate the vehicle with (or without) driver supervision and intervention. The Society for Automotive Engineers (SAE) published SAE J3016 in January 2014 (entitled “Taxonomy and Definitions for Terms Related to Driving Automation Systems for On-Road Motor Vehicles,” revised April 2021) that defines six levels of driving automation for vehicles operating on roadways. SAE’s Levels, which are often referred to as “ADAS Levels,” include Level 0 (no driving automation), Level 1 (driver assistance), Level 2 (partial driving automation), Level 3 (conditional driving automation), Level 4 (high driving automation), and Level 5 (full driving automation).

Generally, each ADAS Level defines the degree to which driver support and automated driving features provided by the control system participate in the dynamic driving task (DDT). The SAE generally defines the DDT as all the real-time functions required to operate a vehicle on the roadway, which includes tactical and operational functions but not strategic functions (such as scheduling, trip planning, or determining the waypoints and stops). For example, the DDT includes lateral (side-to-side) vehicle motion control, longitudinal (forward and backward) vehicle motion control, object and event detection and response, communicating with other vehicles via signaling, lighting, sounding the horn, etc. Expressed another way, the driver support and automated driving features that are engaged at any particular time determine the ADAS Level of driving autonomy for the vehicle.

For ADAS Levels 0, 1, and 2, the driver generally performs the DDT (even if the driver is not steering and the driver’s feet are off the pedals), and must steer, brake, and accelerate as needed to maintain safety. ADAS Level 0 includes driver support features that provide warnings and momentary assistance, such as an automatic emergency braking feature, a blind spot warning feature, a lane departure warning feature, etc. ADAS Level 1 includes driver support features that provide steering or braking/acceleration support, such as a lane centering feature or an adaptive cruise control feature, etc. ADAS Level 2 includes driver support features that provide steering and braking/acceleration support at the same time, such as the lane centering feature and the adaptive cruise control feature. The driver support features provided by the control system may be selected (engaged) and de-selected (disengaged) by the driver.

For ADAS Levels 3, 4, and 5, an automated driving system (ADS) of the ADAS may perform the DDT. Generally, the vehicle control system may include a number of electronic control units (ECUs) that are apportioned between certain functions and control zones of the vehicle. Due to its criticality and complexity, the ADS may be executed by a dedicated ECU. The ADS may provide one or more autonomous driving modes corresponding to ADAS Levels 3, 4, and/or 5, such as a Level 3 autonomous driving mode, a Level 4 autonomous driving mode, and/or a Level 5 autonomous driving mode.

ADAS Level 3 includes automated driving features that drive the vehicle under limited conditions, such as a traffic jam feature, a chauffeur feature, etc. ADAS Level 4 also includes automated driving features that drive the vehicle under limited conditions, such as a local driverless taxi feature, etc. ADAS Level 5 includes automated driving features that drive the vehicle under all conditions. ADAS Levels 4 and 5 do not require that the driver takeover the DDT during autonomous operation. The automated driving features provided by the ADS may be selected (engaged) and de-selected (disengaged) by the driver.

An automated driving mode that has recently gained prominence is hands-off supervised driving. Hands-off supervised driving is generally considered an ADAS Level 2 feature. When hands-off supervised driving is engaged, an ADS may perform the DDT, as discussed above relative to ADAS Levels 3, 4, and 5, and a driver is permitted to remove their hands from a steering wheel; however, the driver generally must keep their eyes on the road and be ready to immediately take over steering, if needed. This is in contrast to ADAS Level 3, for example, where the driver may be permitted to take their eyes off the road during autonomous operation. In some aspects, when hands-off supervised driving is engaged, the driver may be monitored to ensure that their eyes remain on the road.

Accordingly, the ADAS of the vehicle, under various conditions and circumstances, may control steering of the vehicle. Any such control of steering may be referred to herein as an “automatic steering feature.” At times, a fault can occur in the control system that prevents proper operation of an automatic steering feature. The fault may be due to sensor failure, a software or hardware failure in the control system, or the like. Typically, in such a scenario, the automatic steering feature is immediately lost and the driver must instantly assume steering control. Problematically, however, there may be a delay between the time the fault occurs and when the driver is ready to competently assume steering control, for example, by placing their hands on the steering wheel and appropriately controlling the vehicle. This transitional delay could, in some instances, lead to an uncontrollable immediate lane deviation before the driver can safely take control.

The present disclosure describes examples of transitioning to driver-operated steering of a vehicle, for example, in the event of a fault associated with an automatic steering feature. In certain aspects, a vehicle system providing the automatic steering feature can periodically generate, and store in a secondary vehicle system, a pre-calculated dataset based on the system’s processing of vehicle sensor data. In certain aspects, in the event of a fault associated with the automatic steering feature, the secondary vehicle system can temporarily take over the automatic steering feature and, using the pre-calculated dataset, phase out the automatic steering feature over a defined period (e.g., 2 seconds, 3 seconds, 5 seconds, etc.).

Advantageously, in certain aspects, various principles described herein can more effectively and efficiently achieve fault tolerance for the automatic steering feature and its corresponding drive mode, such as hands-off supervised driving. Due to the secondary vehicle system’s ability to temporarily take over, and phase out, the automatic steering feature, additional time may be provided for the driver to place their hands on the steering wheel and safely assume control, thereby preventing a possible fault-induced lane deviation and facilitating a graceful transition to driver-operated steering. Further, in certain aspects, the fault tolerance can be achieved efficiently without adding, for example, controllers, sensors, or systems sufficient for full redundancy. Rather, since the secondary vehicle system’s role can be limited to taking over the automatic steering feature in exceptional circumstances, in open-loop fashion, for a brief period (e.g., 4 seconds, 5 seconds, 6 seconds, etc.), such a system can be an existing vehicle system serving a different primary purpose, or a system with less memory and compute resources than might be necessary or desirable for full redundancy.

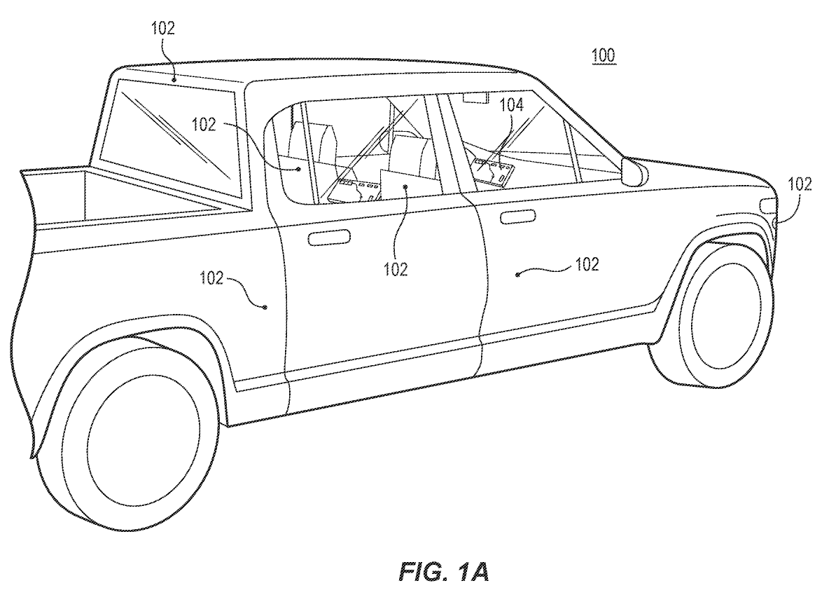

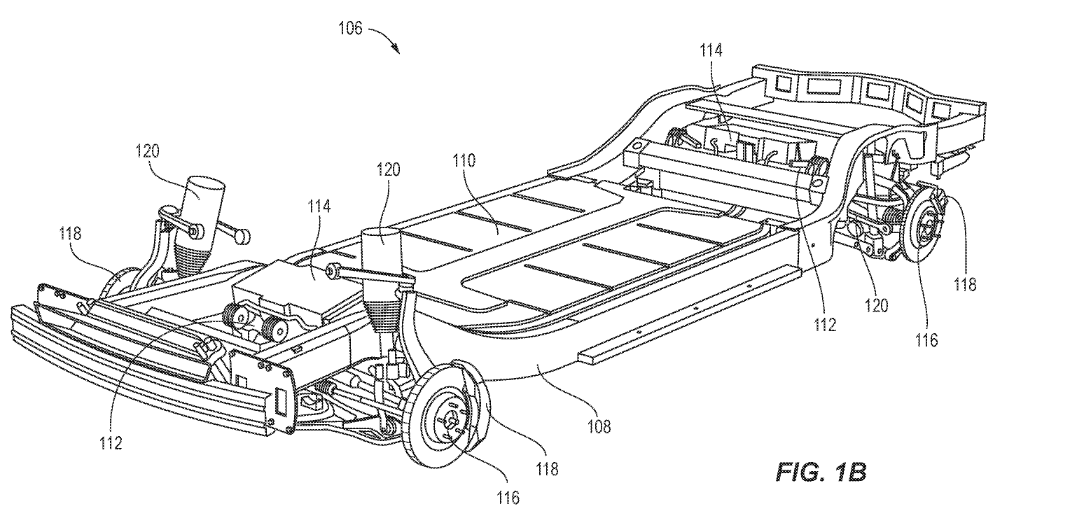

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

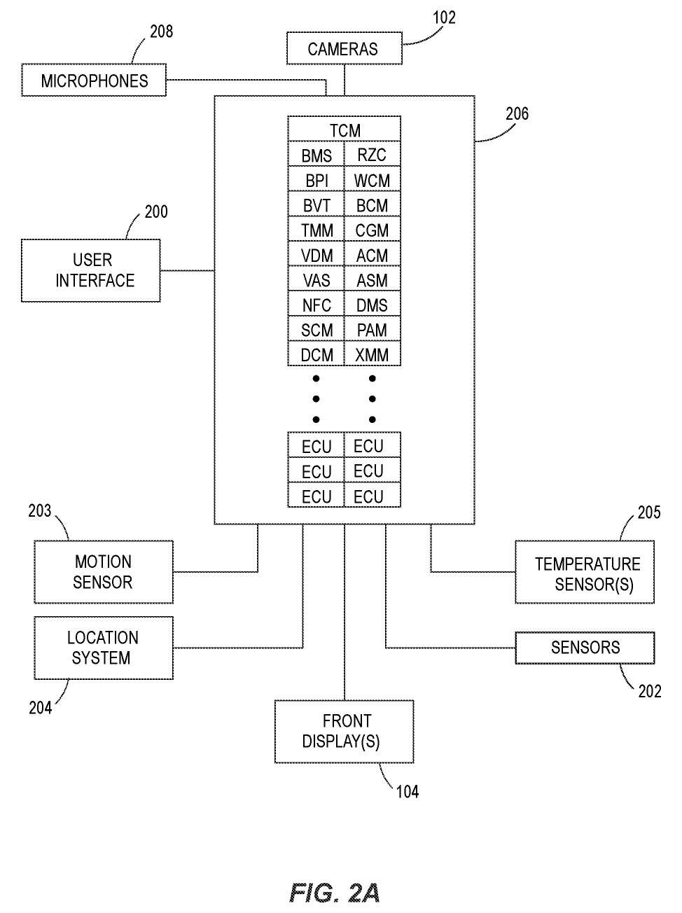

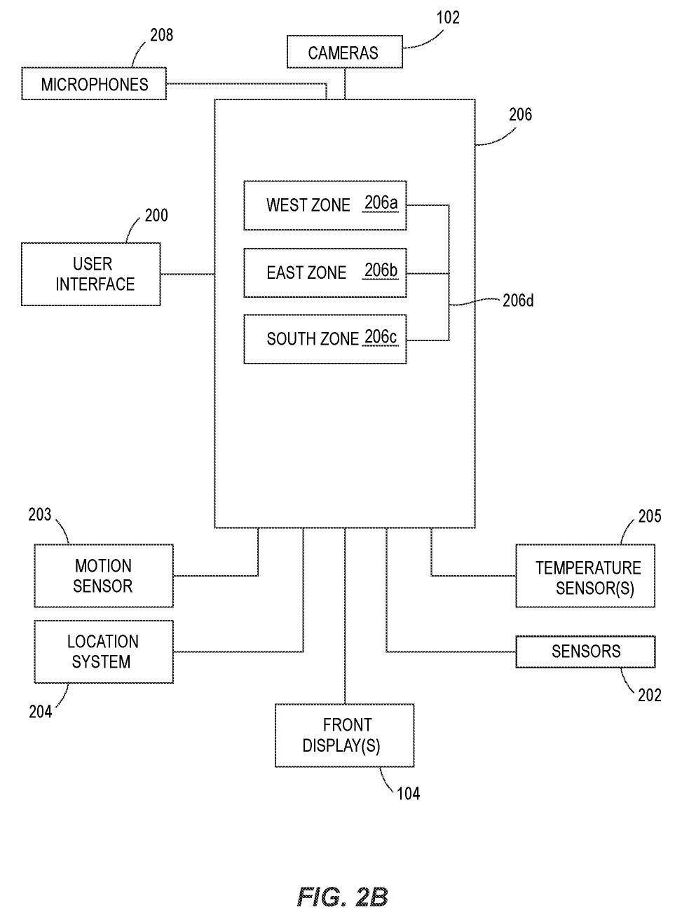

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver and may also include an inertial measurement unit (IMU) (e.g., accelerometers). The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

A control system 206 executes instructions to perform at least some of the actions or functions of the vehicle 100, including the functions described below. For example, as shown in FIG. 2, the control system 206 may include one or more electronic control units (ECUs) configured to perform at least some of the actions or functions of the vehicle 100, including the functions described below. In certain embodiments, each of the ECUs is dedicated to a specific set of functions. Each ECU may be a computer system and each ECU may include functionality described below.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle’s communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described below.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned.

The zonal controllers 206a, 206b, 206c may be connected to one another by a network 206d, such as an Ethernet network, controller area network (CAN), or other type of network.

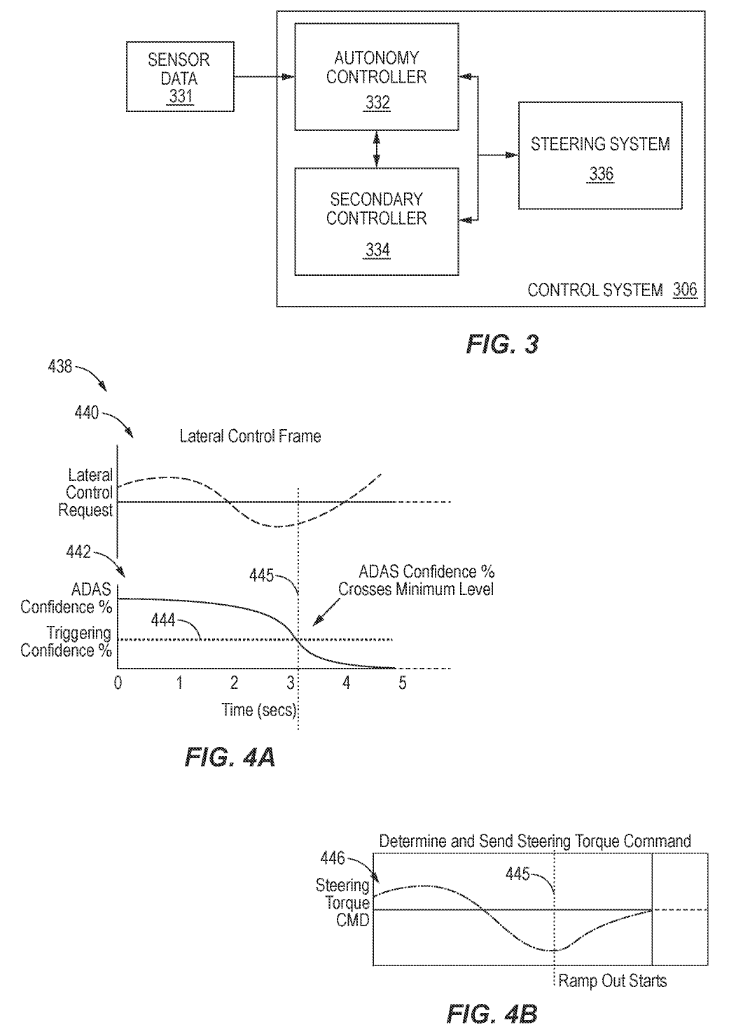

FIG. 3 illustrates an example of a control system 306 for providing fault tolerance for automatic steering features in accordance with certain embodiments. The control system 306 can operate as described, for example, relative to the control system 206 of FIGS. 2A and/or 2B. The control system 306 includes an autonomy controller 332, a secondary controller 334, and a steering system 336.

In various embodiments, the autonomy controller 332 may be any vehicle system operable to provide an automatic steering feature for a vehicle (e.g., the vehicle 100). For example, the autonomy controller 332 can operate as an ADS using sensor data 331 that is received, for example, from the sensors 202 discussed relative to FIG. 2B. In some aspects, the autonomy controller 332 can provide ADAS Level 2 features. For example, the autonomy controller 332 can provide a mode for hands-off supervised driving, such that a driver is permitted to remove their hands from a steering wheel but is not permitted to take their eyes off the road. In addition, or alternatively, the autonomy controller 332 can provide an autonomous driving mode corresponding to ADAS Level 3, such that the driver is additionally permitted to take their eyes off the road. In some aspects, the autonomy controller 332 can be implemented, for example, by an ACM ECU, as discussed relative to FIG. 2B.

In general, the secondary controller 334 can be any vehicle system that can operate independently of the autonomy controller 332 in the event of a fault. The secondary controller 334 typically includes, or has access to, memory and compute resources that are physically separate from the autonomy controller 332. If, for example, the autonomy controller 332 is implemented by an ACM of the control system 306, the secondary controller 334 can be implemented, for example, by any other ECU of the control system 306, such a VDM ECU, an XMM ECU, a BCM ECU, an ASM ECU, a DMS ECU, and/or the like.

In general, the steering system 336 can include a linkage to translate steering commands, for example, to road wheel angles corresponding to orientations, for example, of front wheels or rear wheels of the vehicle 100. In certain aspects, the steering system 336 can be implemented by an ECU of the control system 306. Alternatively, in some aspects, the steering system 336 can be separate from the control system 306.

FIGS. 4A-B illustrate example operation of the control system 306 to provide fault tolerance. FIG. 4A illustrates a lateral control frame 438. In certain aspects, the autonomy controller 332, as part of providing the automatic steering feature for the vehicle, can periodically generate lateral control frames similar to the lateral control frame 438 based on the sensor data 331.

In general, the lateral control frames are pre-calculated datasets that are generated continuously while the automatic steering feature is engaged (e.g., periodically on any suitable interval, such as every second, every 2 seconds, every 3 seconds, etc.). In certain aspects, the autonomy controller 332 can cause each of the lateral control frames to be stored, for example, in memory associated with the secondary controller 334 (e.g., memory that is part of secondary controller 334 or accessible to the secondary controller 334), as each frame is generated. In some aspects, the autonomy controller 332 can, itself, store each of the lateral control frames in the memory associated with the secondary controller 334. In other aspects, the autonomy controller 332 can send each of the lateral control frames to the secondary controller 334, or to another component, to perform the storage.

In certain aspects, the lateral control frames generated by the autonomy controller 332 can include data similar to that of the lateral control frame 438. As illustrated in FIG. 4A, the lateral control frame 438 includes a lateral control request 440 in association with a confidence level 442. The lateral control request 440 can be a pre-calculated future trajectory of the vehicle over a defined period (e.g., 5 seconds, 6 seconds, 7 seconds, etc.). More particularly, the lateral control request 440 can represent planned lateral maneuvers to follow a road, avoid obstructions, etc.

In general, the confidence level 442 can probabilistically indicate confidence in the correctness of the lateral control request over the defined period, with the confidence level generally diminishing over time. The confidence level 442 can be scaled between zero and one, for example, with one indicating highest confidence and zero indicating lowest confidence. In some aspects, the confidence level 442 can be generated based on a probability function, such as an exponential decay function. In addition, or alternatively, the confidence level 442 can correspond to a probability distribution that is selected based on one or more variables, such as the presence or absence of obstructions in view, speed, acceleration, amount of ambient light, traffic, weather, number and location of vehicles in view, etc. In addition, or alternatively, the confidence level 442 can be determined or calculated in any suitable fashion, as will be apparent to one skilled in the art after a detailed review of the present disclosure.

In the example of FIGS. 4A-B, the secondary controller 334 detects a fault in the autonomy controller 332 at a time corresponding to zero seconds of the lateral control frame 438. In response to the fault, the secondary controller 334 accesses the most recent lateral control frame generated by the autonomy controller 332, which frame is the lateral control frame 438 in the example of FIGS. 4A-B, and temporarily takes over the automatic steering feature. As further discussed below, the autonomy controller 332 uses the lateral control frame 438 to phase out the automatic steering feature over a defined period, thereby gracefully transitioning to driver-operated steering of the vehicle. In the example of FIGS. 4A-B, the defined period for the phase-out is a length of the lateral control frame 438 (i.e., 5 seconds), although it should be appreciated that the defined period can also be different from the length of the lateral control frame 438 (e.g., covering only a subset of the length).

With reference now to FIG. 4B, the secondary controller 334 can phase out the automatic steering feature by determining one or more steering torque commands 446 and sending the steering torque command(s) 446 to the steering system 336 for translation and implementation. In the illustrated embodiment, the steering torque command(s) 446 are determined based on the lateral control request 440 and the confidence level 442. In certain aspects, the secondary controller 334 can account for uncertainty in the lateral control request 440 by progressively, or increasingly, moderating a commanded amount of steering torque over the course of the phase-out. In particular, in the illustrated embodiment, the secondary controller 334 is configured to use a predefined confidence threshold 444 as a trigger for the progressive moderation.

With collective reference to FIGS. 4A and 4B, the steering torque command(s) 446 determined by the secondary controller 334 generally conform to the lateral control request 440 until, at time point 445, the confidence threshold 444 is crossed. From the time point 445, a commanded amount of steering torque in the steering torque command(s) 446 is progressively moderated relative to the lateral control request 440, for example, such that the commanded amount is a factor less than the amount indicated in the lateral control request 440. In certain aspects, the factor can become increasingly significant over the rest of the defined period. More particularly, in the example of FIGS. 4A-B, the steering torque command(s) 446 are progressively moderated in proportion to a rate at which the confidence level 442 diminishes. In certain aspects, the progressive moderation can continue until the commanded amount of steering torque in the steering torque command(s) 446 is zero. After the defined period, the phase-out is complete and the driver is expected to be in position to safely operate the vehicle, for example, by having their hands on the steering wheel.

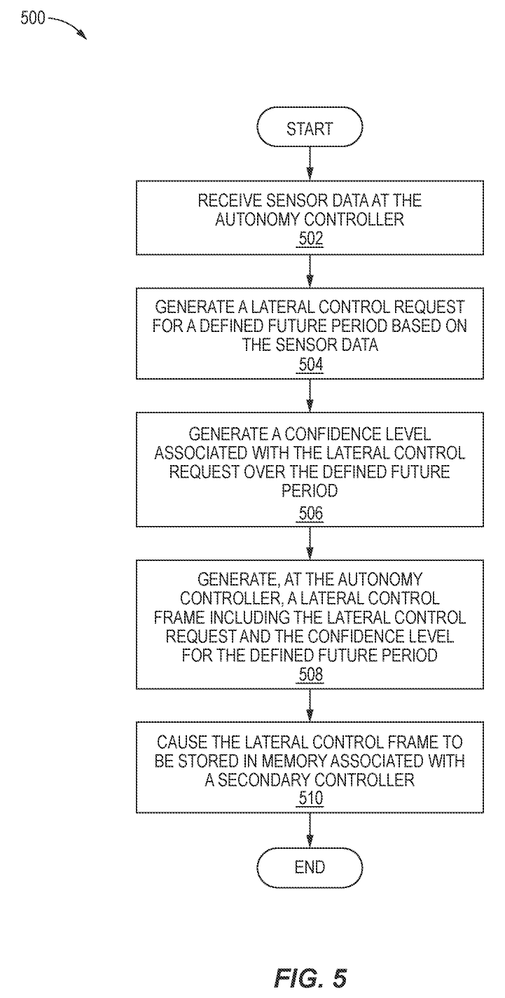

FIG. 5 illustrates an example of a process 500 for generating and storing a lateral control frame in accordance with certain embodiments. In certain aspects, the process 500 can be executed continuously by the autonomy controller 332, for example, at any suitable interval, as the autonomy controller 332 provides an automatic steering feature. In certain aspects, the process 500 can be implemented by any vehicle system that can process data. Although any number of systems, in whole or in part, can implement the process 500, to simplify discussion, the process 500 will be described primarily in relation to the autonomy controller 332 and other components of the control system 306 of FIG. 3.

At block 502, the autonomy controller 332 receives sensor data such as, for example, the sensor data 331 of FIG. 3. At block 504, the autonomy controller 332 generates a lateral control request based on the received sensor data. In general, the lateral control request can be generated as discussed, for example, relative to the lateral control request 440 of FIG. 4A. The lateral control request can be, or can include, a pre-calculated future trajectory over a defined future period, as discussed relative to FIGS. 4A-B.

At block 506, the autonomy controller 332 generates a confidence level associated with the lateral control request over the defined future period. The confidence level can be generated, for example, as discussed relative to the confidence level 442 of FIGS. 4A.

At block 508, the autonomy controller 332 generates a lateral control frame that includes the lateral control request generated at block 504 and the confidence level generated at block 506. The block 508 can include, for example, formatting or structuring the lateral control request and the confidence level into the lateral control frame. The lateral control frame can be similar, for example, to the lateral control frame 438 of FIG. 4A.

At block 510, the autonomy controller 332 causes the lateral control frame generated at block 508 to be stored in memory associated with, or accessible to, the secondary controller 334, as discussed relative to FIGS. 3 and 4A-B. After block 510, the process 500 ends. As discussed previously, in some aspects, the process 500 can execute continuously (e.g., repeating at any suitable interval) as new sensor data is received, such that the secondary controller 334 is continuously updated with new lateral control frames as the automatic steering feature is provided by the autonomy controller 332.

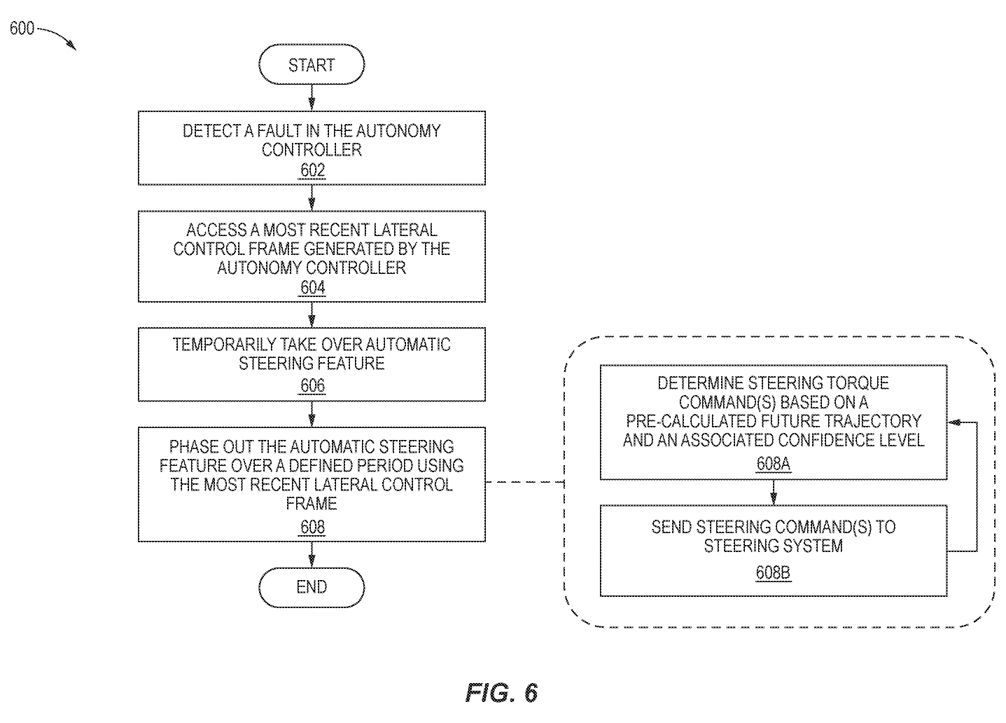

FIG. 6 illustrates an example of a process 600 for generating and storing a lateral control frame in accordance with certain embodiments of the present disclosure. In certain aspects, the process 600 can be executed continuously by the autonomy controller 332, for example, at any suitable interval, as the autonomy controller 332 provides an automatic steering feature. In certain aspects, the process 600 can be implemented by any vehicle system that can process data. Although any number of systems, in whole or in part, can implement the process 600, to simplify discussion, the process 600 will be described primarily in relation to the secondary controller 334 and other components of the control system 306 of FIG. 3.

At block 602, the secondary controller 334 detects a fault in the autonomy controller 332. The fault may be due to sensor failure, a software or hardware failure in the autonomy controller 332, or the like. In some aspects, the secondary controller 334 can detect the failure, for example, by receiving a notification from the autonomy controller 332, by not receiving data that is expected (e.g., a lateral control frame), by receiving a notification from another component of the control system 306, and/or the like. In some aspects, in association with the detected fault, the secondary controller 334, or another component, can cause a notification to a driver that they must assume immediately assume control of the steering wheel. The notification can include any suitable audible, visual, and/or haptic feedback.

At block 604, the secondary controller 334 accesses a most recent lateral control frame generated by the autonomy controller 332. As a result of previous execution of the process 500, the autonomy controller 332 may have caused a plurality of lateral control frames to be stored in the memory associated with the secondary controller 334. According to this example, the most recent lateral control frame can be, for example, the last lateral control frame generated by the autonomy controller 332 prior to the fault. The most recent lateral control frame can be accessed, for example, from the memory associated with the secondary controller 334. The most recent lateral control frame can include, for example, a lateral control request that provides a projected future trajectory over a defined future period, as well as a confidence level associated therewith, as discussed previously.

At block 606, the secondary controller 334 temporarily takes over the automatic steering feature, for example, by taking control of the automatic steering feature from the autonomy controller 332. In certain aspects, the block 606 can involve initiating processing logic on the secondary controller 334 to phase out the automatic steering feature using the most recent lateral control frame accessed at block 604.

At block 608, the secondary controller 334 phases out the automatic steering feature over a defined period using the most recent lateral control frame. The block 608 can involve, for example, the secondary controller 334 temporarily providing the automatic steering feature for a duration of the defined period based on the most recent lateral control frame. The defined period can be, for example, the defined future period of the most recent lateral control frame, or any remaining portion thereof.

In some aspects, as shown, the phasing out at block 608 can include continuously (e.g., repeatedly) executing blocks 608A and 608B over the defined period of the phase-out. At block 608A, the secondary controller 334 determines one or more steering torque commands based on the pre-calculated future trajectory and the associated confidence level. The steering torque command(s) can be determined, for example, as discussed relative to the steering torque command(s) 446 of FIG. 4B. At block 608B, the secondary controller 334 sends the determined steering torque command(s) to the steering system 336 for translation and implementation.

In some aspects, the determining of the steering torque command(s) through each iteration of the block 608A can involve progressively moderating steering torque relative to the pre-calculated future trajectory over at least a portion of the defined period, as discussed relative to FIGS. 4A-B. For example, as discussed relative to FIGS. 4A-B, the secondary controller 334 can progressively moderate steering torque relative to the pre-calculated future trajectory in proportion to a rate at which the confidence level diminishes. In some aspects, as also discussed relative to FIGS. 4A-B, the progressively moderating can be performed (e.g., initiated) in response to the confidence level crossing a threshold confidence level.

After block 608, the process 600 ends. In general, after execution of the process 600, the phase-out is complete and the driver is expected to be in position to safely operate the vehicle.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A method of transitioning to driver-operated steering of a vehicle, the method comprising:
providing, by a first vehicle system, an automatic steering feature for the vehicle;
detecting, by a second vehicle system, a fault in the first vehicle system; and
responsive to the fault, by the second vehicle system:
taking control of the automatic steering feature from the first vehicle system; and
providing the automatic steering feature for a defined period based on a pre-calculated dataset generated by the first vehicle system prior to the fault.

2. The method of claim 1, wherein:
the pre-calculated dataset comprises a pre-calculated future trajectory of the vehicle over the defined period; and
the providing the automatic steering feature for the defined period comprises:
determining one or more steering commands based on the pre-calculated future trajectory; and
sending the one or more steering commands to a steering system of the vehicle.

3. The method of claim 2, wherein the determining the one or more steering commands comprises progressively moderating steering torque relative to the pre-calculated future trajectory over at least a portion of the defined period.

4. The method of claim 2, wherein:
the pre-calculated dataset further comprises a confidence level associated with the pre-calculated future trajectory; and
the determining the one or more steering commands comprises progressively moderating steering torque relative to the pre-calculated future trajectory in proportion to a rate at which the confidence level diminishes.

5. The method of claim 4, wherein the progressively moderating is performed in response to the confidence level crossing a threshold confidence level.

6. The method of claim 1, further comprising, prior to the fault, the first vehicle system generating the pre-calculated dataset and causing the pre-calculated dataset to be stored in memory associated with the second vehicle system.

7. The method of claim 1, further comprising, prior to the fault:
periodically generating, by the first vehicle system, a new pre-calculated dataset based on sensor data; and
causing, by the first vehicle system, the new pre-calculated dataset to be stored in memory associated with the second vehicle system.

8. The method of claim 7, further comprising, prior to the fault:
generating, by the first vehicle system, a first pre-calculated dataset at a first time; and
generating, by the first vehicle system, a second pre-calculated dataset at a second time after the first time, wherein the pre-calculated dataset used while providing the automatic steering feature for the defined period comprises the second pre-calculated dataset.

9. A control system for a vehicle comprising:
a first vehicle system operable to provide an automatic steering feature for the vehicle;
a second vehicle system communicably coupled to the first vehicle system and operable to perform operations comprising:
detecting a fault in the first vehicle system; and
responsive to the fault:
taking control of the automatic steering feature from the first vehicle system; and
providing the automatic steering feature for a defined period based on a pre-calculated dataset generated by the first vehicle system prior to the fault.

10. The control system of claim 9, wherein:
the pre-calculated dataset comprises a pre-calculated future trajectory of the vehicle over the defined period; and
the providing the automatic steering feature for the defined period comprises:
determining one or more steering commands based on the pre-calculated future trajectory; and
sending the one or more steering commands to a steering system of the vehicle.

11. The control system of claim 10, wherein the determining the one or more steering commands comprises progressively moderating steering torque relative to the pre-calculated future trajectory over at least a portion of the defined period.

12. The control system of claim 10, wherein:
the pre-calculated dataset further comprises a confidence level associated with the pre-calculated future trajectory; and
the determining the one or more steering commands comprises progressively moderating steering torque relative to the pre-calculated future trajectory in proportion to a rate at which the confidence level diminishes.

13. The control system of claim 12, wherein the progressively moderating is performed in response to the confidence level crossing a threshold confidence level.

14. The control system of claim 9, wherein, prior to the fault, the first vehicle system is operable to generate the pre-calculated dataset and cause the pre-calculated dataset to be stored in memory associated with the second vehicle system.

15. The control system of claim 9, wherein, prior to the fault, the first vehicle system is further operable to periodically generate a new pre-calculated dataset based on sensor data and cause the new pre-calculated dataset to be stored in memory associated with the second vehicle system.

16. The control system of claim 15, wherein, prior to the fault, the first vehicle system is further operable to:
generate a first pre-calculated dataset at a first time; and
generate a second pre-calculated dataset at a second time after the first time, wherein the pre-calculated dataset used while providing the automatic steering feature for the defined period comprises the second pre-calculated dataset.

17. A computer-program product comprising a non-transitory computer-usable medium having computer-readable program code embodied therein, the computer-readable program code adapted to be executed to implement a method of transitioning to driver-operated steering of a vehicle, the method comprising:
providing, by a first vehicle system, an automatic steering feature for the vehicle;
detecting, by a second vehicle system, a fault in the first vehicle system; and
responsive to the fault, the second vehicle system:
taking control of the automatic steering feature from the first vehicle system; and
providing the automatic steering feature for a defined period based on a pre-calculated dataset generated by the first vehicle system prior to the fault.

18. The computer-program product of claim 17, wherein:
the pre-calculated dataset comprises a pre-calculated future trajectory of the vehicle over the defined period; and
the providing the automatic steering feature for the defined period comprises:
determining one or more steering commands based on the pre-calculated future trajectory; and
sending the one or more steering commands to a steering system of the vehicle.

19. The computer-program product of claim 18, wherein the determining the one or more steering commands comprises progressively moderating steering torque relative to the pre-calculated future trajectory over at least a portion of the defined period.

20. The computer-program product of claim 18, wherein:
the pre-calculated dataset further comprises a confidence level associated with the pre-calculated future trajectory; and
the determining the one or more steering commands comprises progressively moderating steering torque relative to the pre-calculated future trajectory in proportion to a rate at which the confidence level diminishes.
